(19) United States
(12) Patent Application Publication
(10) Pub. No.: US 2025/0310612 A1
(43) Pub. Date: Oct. 2, 2025

(54) SYSTEMS AND METHODS FOR REDUCING CONCURRENT CLIENT REQUESTS DURING STREAMING PLATFORM EVENTS

(71) Applicant: Netflix, Inc., Los Gatos, UT (US)

(72) Inventors: Baskar Natarajan Odayarkoil, San Jose, CA (US); Chandrika Kasi, San Jose, CA (US); Karthik Yagna, San Jose, CA (US)

(21) Appl. No.: 18/622,808

(22) Filed: Mar. 29, 2024

(51) Int. Cl. H04N 21/488; H04N 21/2187; H04N 21/45

(52) U.S. Cl. CPC H04N 21/4882; H04N 21/2187; H04N 21/4508

(57) ABSTRACT

A computer-implemented method and system for reducing concurrent server requests during streaming platform events. For example, the disclosed method and system alleviate pressures on server and network resources during a streaming platform event by causing client devices to stop various targeted functionalities during the event. Once the streaming platform event ends, the disclosed method and system ensure that the targeted functionalities are again resumed on the client devices. Various other methods, systems, and computer-readable media are also disclosed.

### BACKGROUND

Digital content streaming is an increasingly popular activity as viewers turn to digital content streaming platforms to watch movies and episodic content. Previously, digital content streaming was generally limited to pre-recorded content. Recently, digital content streaming platforms have evolved and now offer additional content such as interactive video games and live streaming events (e.g., events that stream live for simultaneous viewing in real-time).

The rise of live and interactive content, however, increases network traffic between client devices and content servers. For example, live content streaming events are subject to last-minute changes and delays. These unexpected issues often lead to concurrent client requests for updated content, event schedules, and so forth. When high numbers of client devices (e.g., millions of client devices) are attempting to stream a live event, these last-minute and often urgent requests can overload network and server resources-leading to server strain, bottlenecking, and other service issues.

### SUMMARY

As will be described in greater detail below, the present disclosure describes implementations that reduce concurrent client requests during streaming platform events. For example, implementations include generating a client message associated with a streaming platform event, wherein the client message indicates a duration of the streaming platform event and one or more targeted client device functionalities, identifying one or more client devices associated with the streaming platform event, and broadcasting the client message to the one or more client devices to cause the one or more client devices to stop the one or more targeted client device functionalities for the duration of the streaming platform event.

In one or more implementations, the streaming platform event includes a live streaming event. Additionally, in some implementations, the one or more targeted client device functionalities include client device functionalities that are at least one of non-user facing client device functionalities or user-facing client device functionalities. Moreover, in at least one implementation, the non-user facing client device functionalities include one or more of logging functionality, prefetch functionality, probe functionality, DNS lookup functionality, gateway retry functionality, or bit-rate cap functionality, and the user-facing client device functionalities include one or more of automatic preview playback functionalities, automatic content playback functionalities, or automatic profile gallery functionalities. In one or more implementations, identifying the one or more client devices associated with the streaming platform event includes identifying the one or more client devices that are associated with the streaming platform event that possess one or more predetermined streaming platform system characteristics.

One or more implementations further include generating an updated client message associated with the streaming platform event, wherein the client message indicates additional targeted client device functionalities, and broadcasting the updated client message to the one or more client devices to cause the one or more client devices to stop the additional targeted client device functionalities for a remaining duration of the streaming platform event.

Additionally, one or more implementations further include generating an updated client message associated with the streaming platform event, wherein the client message indicates an updated duration of the streaming platform event, and broadcasting the client message to the one or more client devices to cause the one or more client devices to resume the one or more targeted client device functionalities in response to determining that the streaming platform event has ended based on the updated duration.

Some examples described herein include a system with at least one physical processor and physical memory including computer-executable instructions that, when executed by the at least one physical processor, cause the at least one physical processor to perform various acts. In at least one example, the computer-executable instructions, when executed by the at least one physical processor, cause the at least one physical processor to perform acts including generating a client message associated with a streaming platform event, wherein the client message indicates a duration of the streaming platform event and one or more targeted client device functionalities, identifying one or more client devices associated with the streaming platform event, and broadcasting the client message to the one or more client devices to cause the one or more client devices to stop the one or more targeted client device functionalities for the duration of the streaming platform event.

In some examples, the above-described method is encoded as computer-readable instructions on a computer-readable medium. In one example, the computer-readable instructions, when executed by at least one processor of a computing device, cause the computing device to generate a client message associated with a streaming platform event, wherein the client message indicates a duration of the streaming platform event and one or more targeted client device functionalities, identify one or more client devices associated with the streaming platform event, and broadcast the client message to the one or more client devices to cause the one or more client devices to stop the one or more targeted client device functionalities for the duration of the streaming platform event.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an overview of a networking environment in which a low network activity system operates to reduce concurrent client device requests during a streaming platform event in accordance with one or more implementations.

FIG. 2 illustrates a flow diagram of a method for reducing non-critical client requests at a streaming platform server during streaming platform events in accordance with one or more implementations.

FIG. 3 illustrates a sequence diagram of how the low network activity system causes client devices to stop non-critical targeted client device functionalities-leading to a reduction in client device requests at streaming platform servers in accordance with one or more implementations.

FIG. 4 illustrates an overview of the low network activity system in accordance with one or more implementations.

FIG. 5 illustrates a block diagram of an exemplary content distribution ecosystem.

FIG. 6 illustrates a block diagram of an exemplary distribution infrastructure within the content distribution ecosystem shown in FIG. 5.

FIG. 7 illustrates a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

As discussed above, streaming platform servers are sometimes inundated with concurrent client requests. To illustrate, due to the unpredictable nature of live streaming events, changes and delays cause client devices to issue requests for updated information, updated display elements, and so forth. When millions of client devices are attempting to stream a live event, an unexpected issue can lead to a crippling volume of server requests. It follows that while the streaming platform servers are attempting to service the urgent requests associated with live streaming events, other less-critical requests can fall by the wayside—leading to additional issues downstream.

In light of this, the present disclosure is generally directed to a system that intelligently reduces certain client requests for a duration of a streaming platform event. For example, in one or more implementations, the system described herein generates a client message associated with a particular streaming platform event such as a live streaming event, a service migration, a scheduled reconfiguration, service degradation, etc. In at least one implementation, the system described herein generates the client message indicating a duration of the streaming platform event as well as targeted client device functionalities that are deemed non-critical. The system described herein then leverages streaming platform connections to broadcast the client message to one or more client devices associated with the live streaming event. Upon receiving the client message, the one or more client devices stop the indicated targeted client device functionalities for the duration of the streaming platform event. In this way, the non-critical functionalities that would otherwise generate requests for the streaming platform servers cease while a higher number of requests associated with the streaming platform event are expected.

As such, the system described herein avoids the pitfalls that accompany streaming platform events that generate high numbers of server requests from client devices. As will be discussed in greater detail below, the system described herein utilizes time-limited functionality restrictions to effectively throttle the number of server requests issued by the client devices associated with a streaming platform event. Thus, the system described herein alleviates the slow downs, bottlenecking, and other network issues that would otherwise occur in connection with streaming platform events.

Features from any of the implementations described herein may be used in combination with one another in accordance with the general principles described herein. These and other implementations, features, and advantages will be more fully understood upon reading the following detailed description in conjunction with the accompanying drawings and claims.

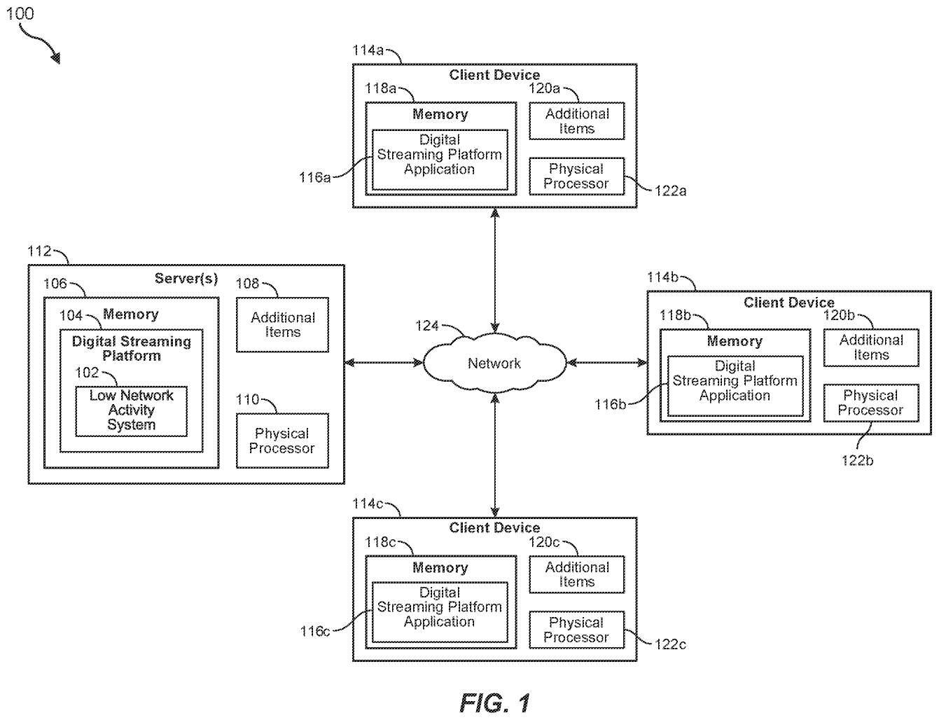

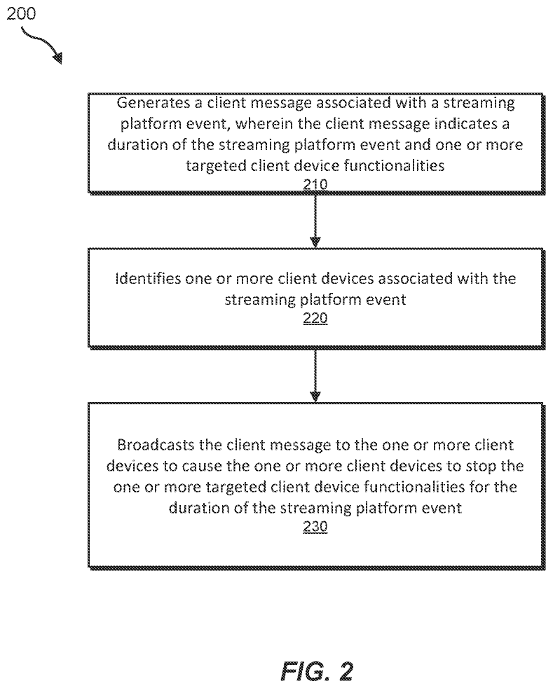

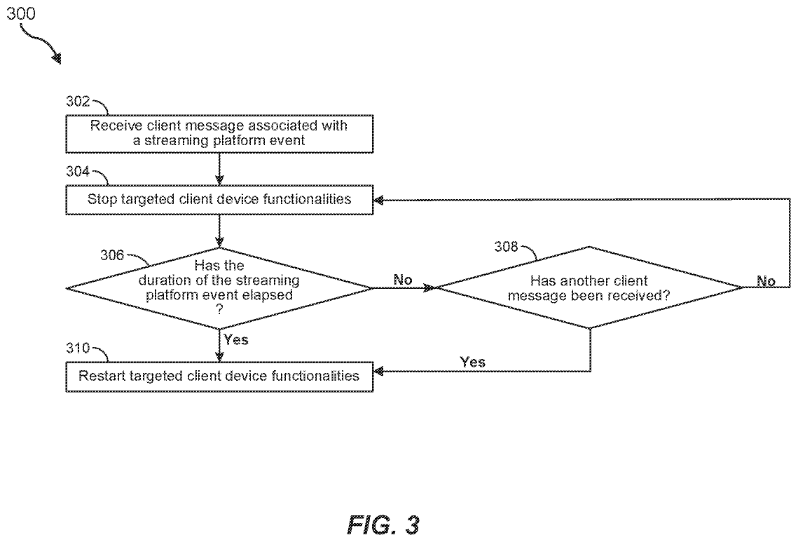

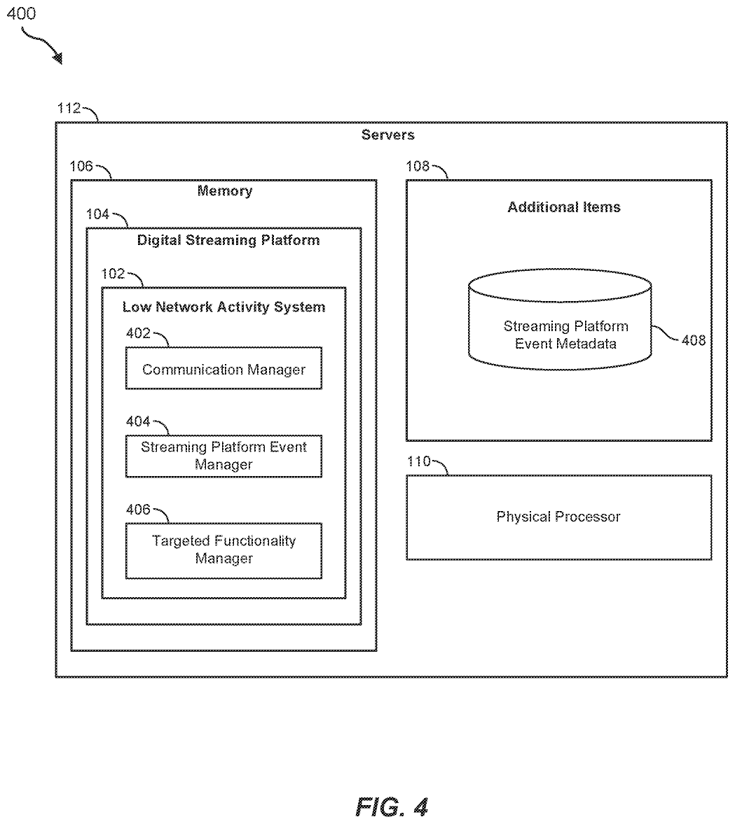

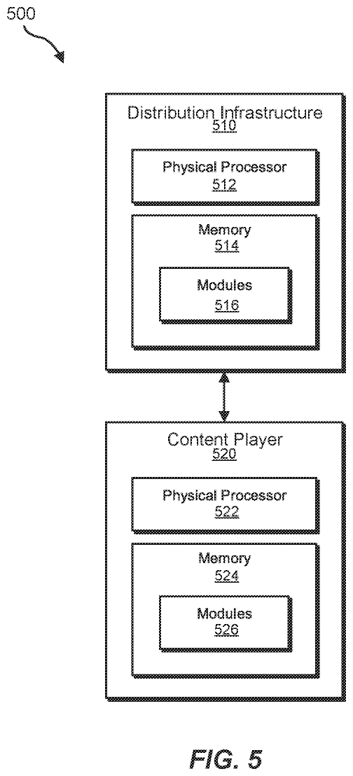

The following will provide, with reference to FIGS. 1-7, detailed description of a low network activity system that effectively reduces concurrent server requests for a duration of a streaming platform event. For example, FIG. 1 illustrates an overview of a networking environment in which the low network activity system operates. FIG. 2 illustrates a flow diagram of a method for reducing non-critical client requests at streaming platform servers during streaming platform events. FIG. 3 illustrates a sequence diagram of how the low network activity system causes client devices to stop non-critical targeted client device functionalities. FIG. 4 illustrates an overview of additional features of the low network activity system. FIGS. 5-7 illustrate additional detail with regard to a content distribution system (e.g., a digital streaming platform).

As mentioned above, FIG. 1 illustrates an exemplary networking environment 100 implementing aspects of the present disclosure. For example, the networking environment 100 includes server(s) 112, client devices 114a, 114b, and 114c, and a network 124. As further shown, the server(s) 112 and the client devices 114a-114c include memories 106, 118a, 118b, and 118c, additional items 108, 120a, 120b, and 120c, and physical processors 110, 122a, 122b, and 122c, respectively.

In one or more implementations, as shown in FIG. 1, the client devices 114a-114c are devices that are capable of digital content item playback. For example, in some implementations, the client devices 114a-114c are any of smartphones, tablets, laptop computers, desktop computers, smart wearables, virtual reality headsets, and so forth. In at least one implementation any of the client devices 114a-114c are set-top devices that receive streamed input from the server(s) 112 and provide the streamed content to a television for playback. In one or more implementations, the client devices 114a-114c are further capable of playback live streamed events originating from the server(s) 112.

As further shown in FIG. 1, a low network activity system 102 is implemented as part of a digital streaming platform 104 within the memory 106 on the server(s) 112. In one or more implementations, the digital streaming platform 104 includes a subscription streaming service for providing digital media content to subscribers. In one or more examples, this digital media content includes non-interactive content such as movies and TV shows, as well as interactive content such as video games. In additional examples, this digital media content further includes live streamed events that are broadcast from the digital streaming platform 104 in real-time. Moreover, the digital streaming platform 104 also provides static information such as menus and selectable thumbnails associated with digital media items.

As further shown in FIG. 1, the client devices 114a-114c include digital streaming platform applications 116a, 116b, and 116c within the memories 118a-118c, respectively. In some implementations, the digital streaming platform applications 116a-116c include some or all of the functionality of the low network activity system 102. In at least one implementation, the digital streaming platform applications 116a-116c generate content requests and transmit these requests to the digital streaming platform 104. In some implementations, the digital streaming platform applications 116a-116c are native applications installed on the client devices 114a-114c. In additional implementations, the digital streaming platform applications 116a-116c are accessed via a web browser installed on the client devices 114a-114c.

As mentioned above, the client devices 114a-114c are communicatively coupled with the server(s) 112 through the network 124. In one or more implementations, the network 124 represents any type or form of communication network, such as the Internet, and includes one or more physical connections, such as a LAN, and/or wireless connections, such as a WAN. In some implementations, the network 124 represents a telecommunications carrier network. In at least one implementation, the network 124 represents combinations of networks.

Although FIG. 1 illustrates components of the exemplary networking environment 100 in one arrangement, other arrangements are possible. For example, in one implementation, the low network activity system 102 operates as a native application installed on any of the client devices 114a-114c. In another implementation, the low network activity system 102 operates across multiple servers. In additional implementations, the exemplary networking environment 100 includes any number of client devices across any number of users, regions, geofenced areas, countries, and so forth.

As mentioned above, FIG. 2 is a flow diagram of an exemplary computer-implemented method 200 for reducing non-critical client requests at a streaming platform server during streaming platform events. The steps shown in FIG. 2 may be performed by any suitable computer-executable code and/or computing system, including the system(s) illustrated in FIG. 4. In one example, each of the steps shown in FIG. 2 may represent an algorithm whose structure includes and/or is represented by multiple sub-steps, examples of which will be provided in greater detail below.

As illustrated in FIG. 2, at step 210 the low network activity system 102 generates a client message associated with a streaming platform event, wherein the client message indicates a duration of the streaming platform event and one or more targeted client device functionalities. For example, in some implementations, the streaming platform event is a list streaming event where digital content is captured and streamed to client devices in real time (e.g., a live comedy show, a live reality TV episode).

As further shown in FIG. 2, at step 220 the low network activity system 102 identifies one or more client devices associated with the streaming platform event. In one or more examples, the low network activity system 102 identifies the one or more client devices based on one or more subscriptions of the one or more client devices. For example, the low network activity system 102 enables the client devices to subscribe to various topics. Topics can be event-specific, geographic area-specific, or specific to other characteristics (e.g., a particular language, particular viewing preferences, etc.). Thus, the low network activity system 102 identifies the one or more client devices associated with the streaming platform event by identifying client devices that are subscribed to the streaming platform event or to topics that are associated with the streaming platform event.

As further shown in FIG. 2, at step 230 the low network activity system 102 broadcasts the client message to the one or more client devices to cause the one or more client devices to stop the one or more targeted client device functionalities for the duration of the streaming platform event. In one or more examples, the targeted client device functionalities indicated by the client message include non-user facing client device functionalities and/or user-facing client device functionalities. Both categories of client device functionalities are those that cause the client devices to send requests to streaming platform servers for various reasons. In one or more implementations, the targeted client device functionalities are deemed non-critical for the duration of the streaming platform event indicated by the client message.

In more detail, FIG. 3 illustrates a sequence 300 of how the low network activity system 102 causes client devices to stop non-critical targeted client device functionalities—leading to a reduction in client device requests at streaming platform servers. For example, at step 302 a client device (e.g., the client device 114a) receives a client message associated with a streaming platform event. In one or more implementations, the client device 114a receives the client message in response to having subscribed to one or more streaming platform topics associated with the streaming platform event.

At step 304, the client device 114a stops targeted client device functionalities indicated by the client message. For example, in some implementations, the client device 114a stops the targeted client device functionalities immediately upon receipt of the client message. In additional implementations, the client device 114a stops the targeted client device functionalities within a timeframe indicated by the client message (e.g., within 100 milliseconds from receipt of the client message). In one or more examples, the client message indicates both a duration of the streaming platform event and one or more targeted client device functionalities. In one or more implementations, the targeted client device functionalities include non-user facing client device functionalities such as logging functionality, prefetch functionality, probe functionality, DNS lookup functionality, gateway retry functionality, or bit-rate cap functionality. In one or more implementations, the targeted client device functionalities further include user-facing functionalities such as automatic preview playback functionalities, automatic content playback functionalities, or automatic profile gallery functionalities.

At step 306, the client device 114a determines whether the duration of the streaming platform event has elapsed. For example, as mentioned above, the client message received by the client device 114a indicates the duration of the streaming platform event. As such, the client device 114a periodically checks whether that duration has elapsed. In one or more examples, the client message indicates the duration of the streaming platform event as an amount of time measured from receipt of the client message (e.g., 15 minutes from receipt of the client message), or an amount of time measured from when the targeted functionalities were stopped by the client device 114a. In additional examples, the client message indicates the duration of the streaming platform event as a timestamp (e.g., the streaming platform event ends at 21:00:00).

In response to determining that the streaming platform event duration has not elapsed (e.g., “No” at step 306), the client device 114a determines whether another client message has been received at step 308. In one or more implementations, the low network activity system 102 can generate and send additional client messages following the initial client message to inform the client device 114a that the streaming platform event has ended unexpectedly. To illustrate, in one example, a live streaming event may be canceled before the planned-for duration elapses. In another example, the streaming platform event may be backend service degradation that has no specific duration. In that event, the low network activity system 102 generates and sends the additional client message when normal backend service is restored and client devices may safely resume full functionality. In response to determining that no additional client messages have been received (e.g., “No” at step 308), the client device 114a continues cessation of the targeted client device functionalities (e.g., as in step 304).

In response to determining that the streaming platform event duration has elapsed (e.g., “Yes” at step 306) or that another client message has been received indicating that the client device 114a should resume targeted functionalities (e.g., “Yes” at step 308), the client device 114a resumes the targeted client device functionalities at step 310. For example, the client device 114a resumes the non-user facing and/or user-facing functionalities indicated in the received client message. In some implementations, the client device 114a resumes the previously stopped functionalities in a particular order. Additionally or alternatively, the client device 114a resumes the previously stopped functionalities with a predetermined level of “jitter” or delay in how the functionalities are resumed to avoid introducing a spike in network traffic and server resource utilization. For example, the low network activity system 102 can instruct the client devices to resume the targeted functionalities every x number of randomized milliseconds so that the server(s) 112 does not experience a “thundering herd” of server messages from the client devices.

As mentioned above, and as shown in FIG. 4, the low network activity system 102 performs various functions in connection with reducing client device requests during a streaming platform event. FIG. 4 is a block diagram 400 of the low network activity system 102 operating within the memory 106 of the server(s) 112 while performing these functions. As such, FIG. 4 provides additional detail with regard to these functions. For example, in one or more implementations as shown in FIG. 4, the low network activity system 102 includes a communication manager 402, a streaming platform event manager 404, and a targeted functionality manager 406. As further shown in FIG. 4, the additional items 108 stores and maintains streaming platform event metadata 408.

In certain implementations, the low network activity system 102 represents one or more software applications, modules, or programs that, when executed by a computing device, may cause the computing device to perform one or more tasks. For example, and as will be described in greater detail below, one or more of the communication manager 402, the streaming platform event manager 404, and the targeted functionality manager 406 may represent software stored and configured to run on one or more computing devices, such as the server(s) 112. One or more of the communication manager 402, the streaming platform event manager 404, or the targeted functionality manager 406 of the low network activity system 102 shown in FIG. 4 may also represent all or portions of one or more special purpose computers to perform one or more tasks.

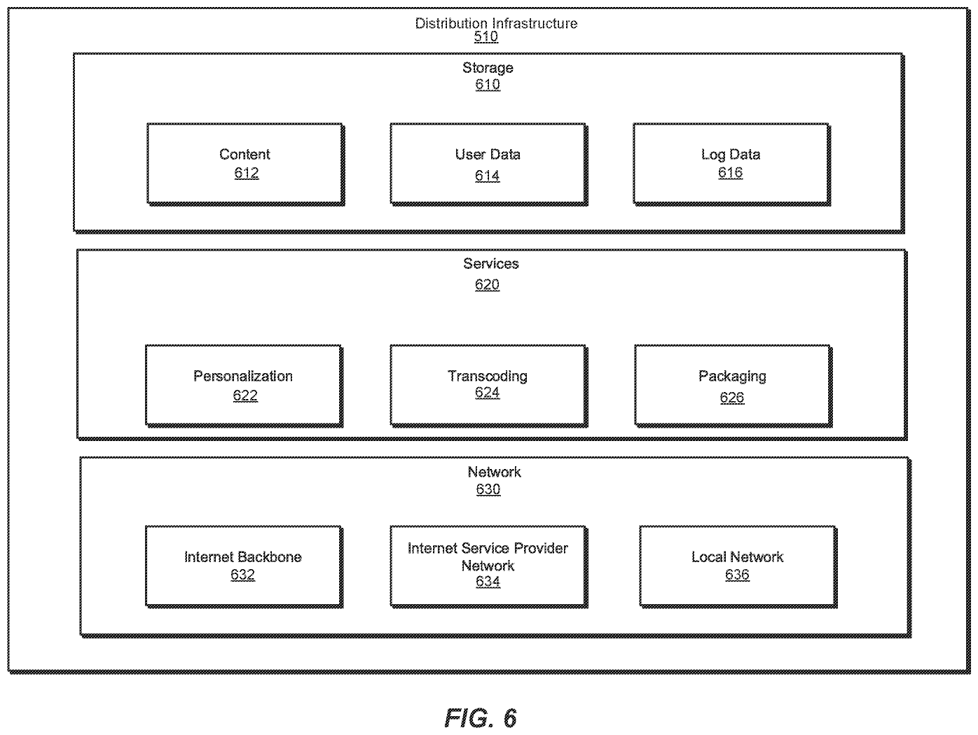

As mentioned above, and as shown in FIG. 6, the low network activity system 102 includes the communication manager 402. In one or more implementations, the communication manager 402 generates client messages and broadcasts client messages to the client devices 114a-114c. For example, as discussed above, the communication manager 402 generates client messages indicating a streaming platform event, the duration of the streaming platform event, and one or more targeted client device functionalities that should stop for the duration of the streaming platform event.

In one or more implementations, the communication manager 402 broadcasts the client messages to the client devices 114a-114c in various ways. For example, in one implementation, the communication manager 402 leverages a near real-time communication channel established by the digital streaming platform 104 to broadcast client messages as dedicated messages to client devices 114a-114c based on subscriptions of those client devices. In at least one example, the communication manager 402 enables the client devices 114a-114c to subscribe (e.g., via a GraphQL subscription) to one or more topics. In at least one implementation, the communication manager 402 organizes the client devices 114a-114c into communication nodes based on their subscriptions. In response to receiving the subscriptions, the communication manager 402 mints subscription keys based on a hash of subscription type and subscription parameters (i.e., meaning the key will be the same for identical subscriptions).

Later, when the communication manager 402 generates a client message associated with a streaming platform event, the communication manager 402 uses targeting information associated with the streaming platform event to look up subscription keys and corresponding communication nodes. The communication manager 402 then broadcasts the client message to the correct client devices via the identified subscription keys and communication nodes. In at least one implementation, the communication manager 402 leverages WebSocket communication protocols to broadcast the client messages.

In additional implementations, the communication manager 402 broadcasts the client message by including the client message as part of the header of an existing message from the digital streaming platform 104. For example, in that implementation, the communication manager 402 includes client message data in an existing message header that includes the reason for the client message (e.g., an indication of the streaming platform event), and the duration of the streaming platform event. In one or more examples, the digital streaming platform application 116a on the client device 114a may have pre-existing instructions regarding one or more targeted client device functionalities to stop in response to different types of streaming platform events.

In one or more implementations, the communication manager 402 accounts for subscribed client devices that tune in to a streaming platform event late. For example, the communication manager 402 keeps a cache of outgoing client messages to be delivered when user devices come online during an event-either late or intermittently. The communication manager 402 then polls the user devices that are tuned in to the streaming platform event at regular intervals during the event to identify late comers or devices that have lost connection and come back online. In one or more examples, the communication manager 402 broadcasts one or more client messages from the cache to these additional client devices to cause the additional client devices to stop one or more targeted client device functionalities for the remaining duration of the streaming platform event.

As mentioned above, and as shown in FIG. 4, the low network activity system 102 includes the streaming platform event manager 404. In one or more implementations, the streaming platform event manager 404 receives and/or detects information associated with streaming platform events. For example, the streaming platform event manager 404 manages information associated with streaming platform events such as live streaming events, brown-out mode events (e.g., planned service shut-downs for servicing, migrations, etc.), network outages, and so forth. In at least one implementation, the streaming platform event manager 404 receives and/or detects information associated with streaming platform events including, but not limited to, event type, classifications and/or subscriptions of client devices that are associated with the streaming platform events, durations of the streaming platform events, and targeted client device functionalities affected by the streaming platform events. In one or more examples, the streaming platform event manager 404 provides this information to the communication manager 402 for use in generating client messages.

As mentioned above, the low network activity system 102 further includes the targeted functionality manager 406. In one or more implementations, the targeted functionality manager 406 determines client device functionalities that are affected by a streaming platform event. For example, the targeted functionality manager 406 determines user-facing functionalities and non-user functionalities associated with a streaming platform event. These functionalities can be communicated to the targeted functionality manager 406 from a service or origin of the streaming platform event. Alternatively, the targeted functionality manager 406 can automatically determine these functionalities based on historical streaming platform performance analysis, network traffic pattern analysis, network usage heuristics, machine learning, and so forth.

In one or more implementations, the non-user facing client device functionalities include one or more of logging functionality (e.g., by stretching out the tempo of regular “heartbeat” client messages to the server(s) 112, by stopping regular system logging messages to the server(s) 112), prefetch functionality (e.g., by stopping prefetches of display content and other personalized content used by the digital streaming platform application 116a), probe functionality (e.g., stop regular client device messages to the server(s) 112 regarding system status and other updates), DNS lookup functionality, gateway retry functionality, or bit-rate cap functionality. Additionally, in one or more implementations, the user-facing client device functionalities include one or more of automatic preview playback functionalities (e.g., stop automatic playback of digital content items in response to landing on a particular page, hovering over a particular thumbnail, etc.), automatic content playback functionalities (e.g., stop automatically downloading an initial portion of a digital content item for faster playback), or automatic profile gallery functionalities (e.g., stop automatically downloading personalized recommendation display content).

In one or more implementations, the targeted functionality manager 406 intelligently ramps up functionality shutdowns while a streaming platform event is ongoing. For example, in at least one implementation, the targeted functionality manager 406 monitors server resources and network bandwidth during a streaming platform event. In response to determining that resource usage and/or network bandwidth are approaching a predetermined critical point, the targeted functionality manager 406 can cause the communication manager 402 to generate and send client messages to the client devices 114a-114c to stop additional functionalities beyond those that have already been stopped—in an effort to avoid potential bottlenecks and other delays.

In one or more implementations, the targeted functionality manager 406 also ensures that client device functionalities that have stopped during a streaming platform event are resumed upon completion of that event. For example, the targeted functionality manager 406 communicates the duration of a streaming platform event to the communication manager 402 for broadcast to the client devices 114a-114c. Additionally, in some implementations, the targeted functionality manager 406 causes the communication manager 402 to generate and broadcast additional client messages that cause the explicit restart of one or more targeted functionalities. In at least one implementation, the targeted functionality manager 406 sets an upper limit of time beyond which all previously stopped functionalities must be resumed as a failsafe that is communicated to the client devices 114a-114c. In one or more examples, the targeted functionality manager 406 causes client device functionalities to include a “jitter” (e.g., a deliberate, slight delay) as they resume. In at least one implementation, the targeted functionality manager 406 introduces this “jitter” as a way to ensure that all of the targeted functionalities across the client devices 114a-114c are not started in the same order and/or within the same timing. This helps avoid the server(s) 112 being overwhelmed as the client devices 114a-114c return to full functionality.

As shown in FIGS. 1 and 4, the server(s) 112 and the client devices 114a-114c include one or more physical processors, such as the physical processors 110 and 122a-122c, respectively. The physical processors 110 and 122a-122c generally represent any type or form of hardware-implemented processing unit capable of interpreting and/or executing computer-readable instructions. In one implementation, the physical processors 110 and 122a-122c access and/or modify one or more of the components of the low network activity system 102. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Additionally as shown in FIGS. 1 and 4, the server(s) 112 and the client devices 114a-114c include memories 106 and 118a-118c, respectively. In one or more implementations, the memories 106 and 118a-118c generally represent any type or form of volatile or non-volatile storage device or medium capable of storing data and/or computer-readable instructions. In one example, the memories 106 and 118a-118c store, load, and/or maintain one or more of the components of the low network activity system 102. Examples of the memories 106 and 118a-118c include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Moreover, as shown in FIG. 4, the server(s) 112 includes the additional items 108. On the server(s) 112, the additional items 108 include streaming platform event metadata 408. In one or more implementations, as discussed above, the streaming platform event metadata 408 includes coordinated schedules and personalized, state-specific metadata associated with a streaming platform event. In some implementations, the streaming platform event metadata 408 includes high cardinality values that are prefetched in advance of a streaming platform event.

In summary, the low network activity system 102 relieves the pressure on system and network resources by intelligently causing client devices to reduce server requests during a streaming platform event. For example, and as discussed above, the low network activity system 102 generates and broadcasts client messages that cause client devices associated with the streaming platform event to stop targeted functionalities that would otherwise include sending server requests during the event. In one or more implementations, as discussed above, the stopped functionalities are generally non-critical and allow for server and network resources to become more available for the streaming platform event. The low network activity system 102 further builds various fail safes into the client messaging that ensure the client devices 114a-114c resume the targeted functionalities once the streaming platform event has ended or once an upper limit of time has been reached.

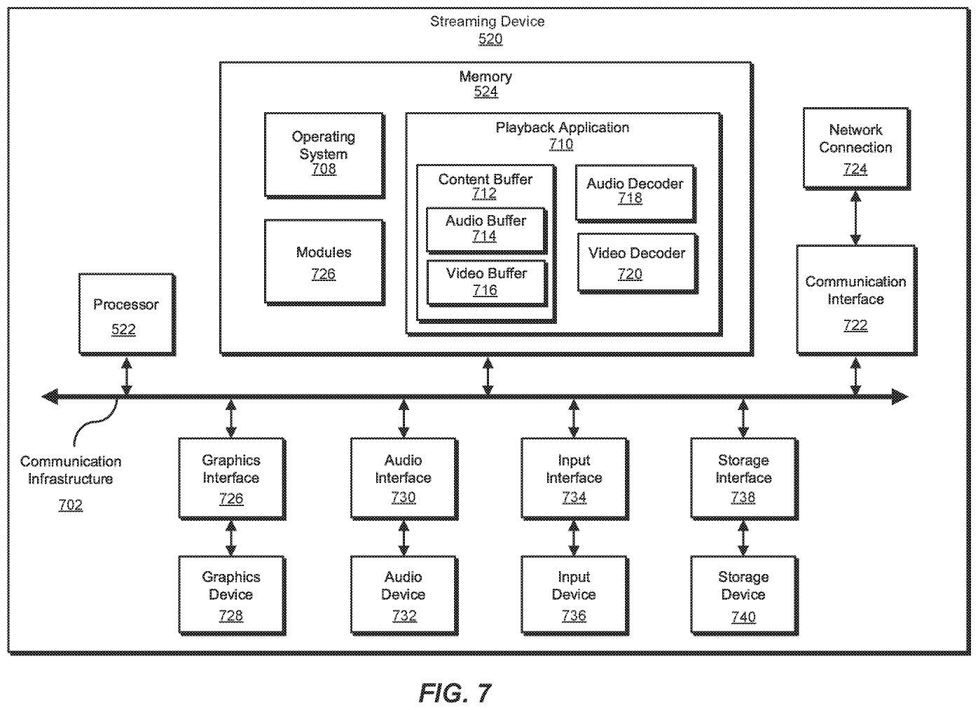

The following will provide, with reference to FIG. 5, detailed descriptions of exemplary ecosystems in which content is provisioned to end nodes and in which requests for content are steered to specific end nodes. The discussion corresponding to FIGS. 6 and 7 presents an overview of an exemplary distribution infrastructure and an exemplary content player used during playback sessions, respectively. These exemplary ecosystems and distribution infrastructures are implemented in any of the embodiments described above with reference to FIGS. 1-4.

FIG. 5 is a block diagram of a content distribution ecosystem 500 that includes a distribution infrastructure 510 in communication with a content player 520. In some embodiments, distribution infrastructure 510 is configured to encode data at a specific data rate and to transfer the encoded data to content player 520. Content player 520 is configured to receive the encoded data via distribution infrastructure 510 and to decode the data for playback to a user. The data provided by distribution infrastructure 510 includes, for example, audio, video, text, images, animations, interactive content, haptic data, virtual or augmented reality data, location data, gaming data, or any other type of data that is provided via streaming.

Distribution infrastructure 510 generally represents any services, hardware, software, or other infrastructure components configured to deliver content to end users. For example, distribution infrastructure 510 includes content aggregation systems, media transcoding and packaging services, network components, and/or a variety of other types of hardware and software. In some cases, distribution infrastructure 510 is implemented as a highly complex distribution system, a single media server or device, or anything in between. In some examples, regardless of size or complexity, distribution infrastructure 510 includes at least one physical processor 512 and memory 514. One or more modules 516 are stored or loaded into memory 514 to enable adaptive streaming, as discussed herein.

Content player 520 generally represents any type or form of device or system capable of playing audio and/or video content that has been provided over distribution infrastructure 510. Examples of content player 520 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 510, content player 520 includes a physical processor 522, memory 524, and one or more modules 526. Some or all of the adaptive streaming processes described herein is performed or enabled by modules 526, and in some examples, modules 516 of distribution infrastructure 510 coordinate with modules 526 of content player 520 to provide adaptive streaming of digital content.

In certain embodiments, one or more of modules 516 and/or 526 in FIG. 5 represent one or more software applications or programs that, when executed by a computing device, cause the computing device to perform one or more tasks. For example, and as will be described in greater detail below, one or more of modules 516 and 526 represent modules stored and configured to run on one or more general-purpose computing devices. One or more of modules 516 and 526 in FIG. 5 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 512 and 522 generally represent any type or form of hardware-implemented processing unit capable of interpreting and/or executing computer-readable instructions. In one example, physical processors 512 and 522 access and/or modify one or more of modules 516 and 526, respectively. Additionally or alternatively, physical processors 512 and 522 execute one or more of modules 516 and 526 to facilitate adaptive streaming of digital content. Examples of physical processors 512 and 522 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 514 and 524 generally represent any type or form of volatile or non-volatile storage device or medium capable of storing data and/or computer-readable instructions. In one example, memory 514 and/or 524 stores, loads, and/or maintains one or more of modules 516 and 526. Examples of memory 514 and/or 524 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 6 is a block diagram of exemplary components of distribution infrastructure 510 according to certain embodiments. Distribution infrastructure 510 includes storage 610, services 620, and a network 630. Storage 610 generally represents any device, set of devices, and/or systems capable of storing content for delivery to end users. Storage 610 includes a central repository with devices capable of storing terabytes or petabytes of data and/or includes distributed storage systems (e.g., appliances that mirror or cache content at Internet interconnect locations to provide faster access to the mirrored content within certain regions). Storage 610 is also configured in any other suitable manner.

As shown, storage 610 may store a variety of different items including content 612, user data 614, and/or log data 616. Content 612 includes television shows, movies, video games, user-generated content, and/or any other suitable type or form of content. User data 614 includes personally identifiable information (PII), payment information, preference settings, language and accessibility settings, and/or any other information associated with a particular user or content player. Log data 616 includes viewing history information, network throughput information, and/or any other metrics associated with a user's connection to or interactions with distribution infrastructure 510.

Services 620 includes personalization services 622, transcoding services 624, and/or packaging services 626. Personalization services 622 personalize recommendations, content streams, and/or other aspects of a user's experience with distribution infrastructure 510. Transcoding services 624 compress media at different bitrates which, as described in greater detail below, enable real-time switching between different encodings. Packaging services 626 package encoded video before deploying it to a delivery network, such as network 630, for streaming.

Network 630 generally represents any medium or architecture capable of facilitating communication or data transfer. Network 630 facilitates communication or data transfer using wireless and/or wired connections. Examples of network 630 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 6, network 630 includes an Internet backbone 632, an internet service provider network 634, and/or a local network 636. As discussed in greater detail below, bandwidth limitations and bottlenecks within one or more of these network segments triggers video and/or audio bit rate adjustments.

FIG. 7 is a block diagram of an exemplary implementation of content player 520 of FIG. 5. Content player 520 generally represents any type or form of computing device capable of reading computer-executable instructions. Content player 520 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 7, in addition to processor 522 and memory 524, content player 520 includes a communication infrastructure 702 and a communication interface 722 coupled to a network connection 724. Content player 520 also includes a graphics interface 726 coupled to a graphics device 728, an audio interface 730 coupled to an audio device 732, an input interface 734 coupled to an input device 736, and a storage interface 738 coupled to a storage device 740.

Communication infrastructure 702 generally represents any type or form of infrastructure capable of facilitating communication between one or more components of a computing device. Examples of communication infrastructure 702 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 524 generally represents any type or form of volatile or non-volatile storage device or medium capable of storing data and/or other computer-readable instructions. In some examples, memory 524 stores and/or loads an operating system 708 for execution by processor 522. In one example, operating system 708 includes and/or represents software that manages computer hardware and software resources and/or provides common services to computer programs and/or applications on content player 520.

Operating system 708 performs various system management functions, such as managing hardware components (e.g., graphics interface 726, audio interface 730, input interface 734, and/or storage interface 738). Operating system 708 also provides process and memory management models for playback application 710. The modules of playback application 710 includes, for example, a content buffer 712, an audio decoder 718, and a video decoder 720.

Playback application 710 is configured to retrieve digital content via communication interface 722 and play the digital content through graphics interface 726 and audio interface 730. Graphics interface 726 is configured to transmit a rendered video signal to graphics device 728. Audio interface 730 is configured to transmit a rendered audio signal to audio device 732. In normal operation, playback application 710 receives a request from a user to play a specific title or specific content. Playback application 710 then identifies one or more encoded video and audio streams associated with the requested title.

In one embodiment, playback application 710 begins downloading the content associated with the requested title by downloading sequence data encoded to the lowest audio and/or video playback bitrates to minimize startup time for playback. The requested digital content file is then downloaded into content buffer 712, which is configured to serve as a first-in, first-out queue. In one embodiment, each unit of downloaded data includes a unit of video data or a unit of audio data. As units of video data associated with the requested digital content file are downloaded to the content player 520, the units of video data are pushed into the content buffer 712. Similarly, as units of audio data associated with the requested digital content file are downloaded to the content player 520, the units of audio data are pushed into the content buffer 712. In one embodiment, the units of video data are stored in video buffer 716 within content buffer 712 and the units of audio data are stored in audio buffer 714 of content buffer 712.

A video decoder 720 reads units of video data from video buffer 716 and outputs the units of video data in a sequence of video frames corresponding in duration to the fixed span of playback time. Reading a unit of video data from video buffer 716 effectively de-queues the unit of video data from video buffer 716. The sequence of video frames is then rendered by graphics interface 726 and transmitted to graphics device 728 to be displayed to a user.

An audio decoder 718 reads units of audio data from audio buffer 714 and outputs the units of audio data as a sequence of audio samples, generally synchronized in time with a sequence of decoded video frames. In one embodiment, the sequence of audio samples is transmitted to audio interface 730, which converts the sequence of audio samples into an electrical audio signal. The electrical audio signal is then transmitted to a speaker of audio device 732, which, in response, generates an acoustic output.

In situations where the bandwidth of distribution infrastructure 510 is limited and/or variable, playback application 710 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 726 is configured to generate frames of video data and transmit the frames of video data to graphics device 728. In one embodiment, graphics interface 726 is included as part of an integrated circuit, along with processor 522. Alternatively, graphics interface 726 is configured as a hardware accelerator that is distinct from (i.e., is not integrated within) a chipset that includes processor 522.

Graphics interface 726 generally represents any type or form of device configured to forward images for display on graphics device 728. For example, graphics device 728 is fabricated using liquid crystal display (LCD) technology, cathode-ray technology, and light-emitting diode (LED) display technology (either organic or inorganic). In some embodiments, graphics device 728 also includes a virtual reality display and/or an augmented reality display. Graphics device 728 includes any technically feasible means for generating an image for display. In other words, graphics device 728 generally represents any type or form of device capable of visually displaying information forwarded by graphics interface 726.

As illustrated in FIG. 7, content player 520 also includes at least one input device 736 coupled to communication infrastructure 702 via input interface 734. Input device 736 generally represents any type or form of computing device capable of providing input, either computer or human generated, to content player 520. Examples of input device 736 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 520 also includes a storage device 740 coupled to communication infrastructure 702 via a storage interface 738. Storage device 740 generally represents any type or form of storage device or medium capable of storing data and/or other computer-readable instructions. For example, storage device 740 is a magnetic disk drive, a solid-state drive, an optical disk drive, a flash drive, or the like. Storage interface 738 generally represents any type or form of interface or device for transferring data between storage device 740 and other components of content player 520.

### EXAMPLE EMBODIMENTS

Example 1: A computer-implemented method that reduces concurrent server requests during streaming platform events. For example, the method may include generating a client message associated with a streaming platform event, wherein the client message indicates a duration of the streaming platform event and one or more targeted client device functionalities, identifying one or more client devices associated with the streaming platform event, and broadcasting the client message to the one or more client devices to cause the one or more client devices to stop the one or more targeted client device functionalities for the duration of the streaming platform event.

Example 2: The computer-implemented method of Example 1, wherein the streaming platform event includes a live streaming event.

Example 3: The computer-implemented method of any of Examples 1 and 2, wherein the one or more targeted client device functionalities include client device functionalities that are at least one of non-user facing client device functionalities or user-facing client device functionalities.

Example 4: The computer-implemented method of any of Examples 1-3, wherein the non-user facing client device functionalities include one or more of logging functionality, prefetch functionality, probe functionality, DNS lookup functionality, gateway retry functionality, or bit-rate cap functionality.

Example 5: The computer-implemented method of any of Examples 1-4, wherein the user-facing client device functionalities include one or more of automatic preview playback functionalities, automatic content playback functionalities, or automatic profile gallery functionalities.

Example 6: The computer-implemented method of any of Examples 1-5, wherein identifying the one or more client devices associated with the streaming platform event includes identifying the one or more client devices that are associated with the streaming platform event that possess one or more predetermined streaming platform system characteristics.

Example 7: The computer-implemented method of any of Examples 1-6, further including generating an updated client message associated with the streaming platform event, wherein the client message indicates additional targeted client device functionalities, and broadcasting the updated client message to the one or more client devices to cause the one or more client devices to stop the additional targeted client device functionalities for a remaining duration of the streaming platform event.

Example 8: The computer-implemented method of any of Examples 1-8, further including generating an updated client message associated with the streaming platform event, wherein the client message indicates an updated duration of the streaming platform event, and broadcasting the client message to the one or more client devices to cause the one or more client devices to resume the one or more targeted client device functionalities in response to determining that the streaming platform event has ended based on the updated duration.

In some examples, a system may include at least one processor and a physical memory including computer-executable instructions that, when executed by the at least one processor, cause the at least one processor to perform various acts. For example, the computer-executable instructions may cause the at least one processor to perform acts including generating a client message associated with a streaming platform event, wherein the client message indicates a duration of the streaming platform event and one or more targeted client device functionalities, identifying one or more client devices associated with the streaming platform event, and broadcasting the client message to the one or more client devices to cause the one or more client devices to stop the one or more targeted client device functionalities for the duration of the streaming platform event.

In some examples, a method may be encoded as non-transitory, computer-readable instructions on a computer-readable medium. In one example, the computer-readable instructions, when executed by at least one processor of a computing device, cause the computing device to generate a client message associated with a streaming platform event, wherein the client message indicates a duration of the streaming platform event and one or more targeted client device functionalities, identify one or more client devices associated with the streaming platform event, and broadcast the client message to the one or more client devices to cause the one or more client devices to stop the one or more targeted client device functionalities for the duration of the streaming platform event.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of,” Finally, for ease of use, the terms “including” and “having” (and their derivatives), as used in the specification and claims, are interchangeable with and have the same meaning as the word “comprising.”

What is claimed is:

1. A computer-implemented method comprising:
generating a client message associated with a streaming platform event, wherein the client message indicates a duration of the streaming platform event and one or more targeted client device functionalities;
identifying one or more client devices associated with the streaming platform event; and
broadcasting the client message to the one or more client devices to cause the one or more client devices to stop the one or more targeted client device functionalities for the duration of the streaming platform event.

2. The computer-implemented method of claim 1, wherein the streaming platform event comprises a live streaming event.

3. The computer-implemented method of claim 1, wherein the one or more targeted client device functionalities comprise client device functionalities that are at least one of non-user facing client device functionalities or user-facing client device functionalities.

4. The computer-implemented method of claim 3, wherein the non-user facing client device functionalities comprise one or more of logging functionality, prefetch functionality, probe functionality, DNS lookup functionality, gateway retry functionality, or bit-rate cap functionality.

5. The computer-implemented method of claim 3, wherein the user-facing client device functionalities comprise one or more of automatic preview playback functionalities, automatic content playback functionalities, or automatic profile gallery functionalities.

6. The computer-implemented method of claim 1, wherein identifying the one or more client devices associated with the streaming platform event comprises identifying the one or more client devices that are associated with the streaming platform event that possess one or more predetermined streaming platform system characteristics.

7. The computer-implemented method of claim 1, further comprising:
generating an updated client message associated with the streaming platform event, wherein the client message indicates additional targeted client device functionalities; and
broadcasting the updated client message to the one or more client devices to cause the one or more client devices to stop the additional targeted client device functionalities for a remaining duration of the streaming platform event.

8. The computer-implemented method of claim 1, further comprising:
generating an updated client message associated with the streaming platform event, wherein the client message indicates an updated duration of the streaming platform event; and
broadcasting the client message to the one or more client devices to cause the one or more client devices to resume the one or more targeted client device functionalities in response to determining that the streaming platform event has ended based on the updated duration.

9. A system comprising:
at least one physical processor; and
physical memory comprising computer-executable instructions that, when executed by the at least one physical processor, cause the at least one physical processor to perform acts comprising:
generating a client message associated with a streaming platform event, wherein the client message indicates a duration of the streaming platform event and one or more targeted client device functionalities;
identifying one or more client devices associated with the streaming platform event; and
broadcasting the client message to the one or more client devices to cause the one or more client devices to stop the one or more targeted client device functionalities for the duration of the streaming platform event.

10. The system of claim 9, wherein the streaming platform event comprises a live streaming event.

11. The system of claim 9, wherein the one or more targeted client device functionalities comprise client device functionalities that are at least one of non-user facing client device functionalities, or user-facing client device functionalities.

12. The system of claim 11, wherein the non-user facing client device functionalities comprise one or more of logging functionality, prefetch functionality, probe functionality, DNS lookup functionality, gateway retry functionality, or bit-rate cap functionality.

13. The system of claim 11, wherein the user-facing client device functionalities comprise one or more of automatic preview playback functionalities, automatic content playback functionalities, or automatic profile gallery functionalities.

14. The system of claim 9, wherein identifying the one or more client devices associated with the streaming platform event comprises identifying the one or more client devices that are associated with the streaming platform event that possess one or more predetermined streaming platform system characteristics.

15. The system of claim 9, further comprising computer-executable instructions that, when executed by the at least one physical processor, cause the at least one physical processor to perform acts comprising:
generating an updated client message associated with the streaming platform event, wherein the client message indicates additional targeted client device functionalities; and
broadcasting the updated client message to the one or more client devices to cause the one or more client devices to stop the additional targeted client device functionalities for a remaining duration of the streaming platform event.

16. The system of claim 9, further comprising computer-executable instructions that, when executed by the at least one physical processor, cause the at least one physical processor to perform acts comprising:
generating an updated client message associated with the streaming platform event, wherein the client message indicates an updated duration of the streaming platform event; and
broadcasting the client message to the one or more client devices to cause the one or more client devices to resume the one or more targeted client device functionalities in response to determining that the streaming platform event has ended based on the updated duration.

17. A non-transitory computer-readable medium comprising one or more computer-executable instructions that, when executed by at least one processor of a computing device, cause the computing device to:
generate a client message associated with a streaming platform event, wherein the client message indicates a duration of the streaming platform event and one or more targeted client device functionalities;
identify one or more client devices associated with the streaming platform event; and
broadcast the client message to the one or more client devices to cause the one or more client devices to stop the one or more targeted client device functionalities for the duration of the streaming platform event.

18. The non-transitory computer-readable medium of claim 17, wherein the streaming platform event comprises a live streaming event.

19. The non-transitory computer-readable medium of claim 17, further comprising one or more computer-executable instructions that, when executed by the at least one processor of the computing device, cause the computing device to:
generate an updated client message associated with the streaming platform event, wherein the client message indicates additional targeted client device functionalities; and
broadcast the updated client message to the one or more client devices to cause the one or more client devices to stop the additional targeted client device functionalities for a remaining duration of the streaming platform event.

20. The non-transitory computer-readable medium of claim 17, further comprising one or more computer-executable instructions that, when executed by the at least one processor of the computing device, cause the computing device to:
generate an updated client message associated with the streaming platform event, wherein the client message indicates an updated duration of the streaming platform event; and
broadcast the client message to the one or more client devices to cause the one or more client devices to resume the one or more targeted client device functionalities in response to determining that the streaming platform event has ended based on the updated duration.
